(19) United States
(12) Patent Application Publication
(10) Pub. No.: US 2008/0032099 A1
(43) Pub. Date: Feb. 7, 2008

(54) HEAT ACTIVATED ART MOUNTING SHEET

(75) Inventor: Donald DRESSLER, Glastonbury, CT (US)

Correspondence Address: MCNEES WALLACE & NURICK LLC, 100 PINE STREET, P.O. BOX 1166, HARRISBURG, PA, 17108-1166, US

(73) Assignee: ELMER'S PRODUCTS, INC., Columbus, OH (US)

(21) Appl. No.: 11/458,760

(22) Filed: Jul. 20, 2006

(51) Int. Cl. B32B 7/14; B32B 27/30

(52) U.S. Cl. 428/201; 428/537.1; 428/522; 428/211.1; 427/207.1

(57) ABSTRACT

An apparatus is provided for mounting an art sheet to a rigid substrate, the apparatus including an adhesive coated paper sheet, the paper sheet made of cotton fibers and having a discontinuous adhesive coating on at least one side thereof. The discontinuous adhesive coating preferably includes a thermoplastic resin. Methods are also provided for manufacturing the adhesive coated mounting sheet. A mounting package is provided wherein a two-sided embodiment of the mounting sheet is combined with a rigid substrate and an art print to form a multi-layer sandwich assembly. The sandwich assembly is then laminated to melt the adhesive and force out air, thereby converting the discontinuous adhesive coating into a thin and substantially continuous adhesive layer that permanently adheres the paper, substrate, and art print into a unitary mounting package suitable for framing or display.

### FIELD OF THE INVENTION

The present invention is directed to mounting of artwork suitable for framing, and more particularly to heat activated sheet materials for mounting and preservation of photographs and other works of art.

### BACKGROUND OF THE INVENTION

Mounting is a way to preserve a sheet item, such as an art print or photograph, by attaching it to a rigid substrate for added support. Mounting allows the preservation and visual presentation of a sheet item, and further facilitates framing of the item if desired. Traditional rigid substrates for mounting a sheet item consist of mat boards, foam boards, masonite, medium density fiberboard, and the like. Professionals in the art and framing businesses are very careful when choosing and using mounting materials, and endeavor to ensure that no damage will result to the mounted item. Damage can occur by any of several means at various times, both during mounting and thereafter. For example, water or solvent damage during mounting can occur when wet mounting methods are used. In dry mounting methods, damage can result from air bubbles forming between the art sheet and the substrate due to loss of adhesive properties of the mounting sheet over time, and from leaching of any adhesive into the art sheet. After mounting, damage can occur from degradation of the mounting materials, including degradation of the sheet materials, adhesives, and/or the art piece itself. Degradation can include changes due to exposure to air and other elements, or from slow chemical reactions involving the various mounting materials and/or artwork.

In an effort to minimize damage from wet mounting methods, Kodak introduced the first dry mounting tissue (a paper coated with adhesive) around 1906. In 1934, an improved version was introduced, and that version remained unchanged until about 1974. In 1955, another significant manufacturer in the form of a Connecticut company named Seal, introduced its first dry mount tissue.

As a result of Kodak and Seal's inventions, many items including fiber and resin coated photographic prints, posters, maps, charts, and other sheet art and documents are now customarily dry mounted with a heat activated adhesive. Such mountings are usually performed using a heated vacuum or mechanical press. The temperature and dwell times may vary depending on the item to be mounted and the base substrate that the item is mounted to. A number of companies have also introduced rigid mounting substrates that are made specifically to limit the risk of damaging mounted art items over a period of time. For example, available mounting substrates include 100% cotton rag mat board and 100% cotton-faced foam board. However, while such cotton rag boards are known, at the present time there are no mounting adhesives that are provided on 100% cotton paper sheets to provide a 100% cotton rag heat-activated mounting tissue.

There is a long-felt need for a dry adhesive mounting paper that is compatible with known 100% cotton base rigid substrates, and that is particularly compatible for mounting fine art such as Giclee prints that have recently become quite popular in many galleries and frame shops. Giclee prints require non-acidic, non-reactive mounting substrates and associated adhesives due to the very complex coatings on Giclee print surfaces. Those coatings react in a negative way to nearly all known dry mounting sheets, also known as tissue mounting papers, with the most common problem being that yellow spots appear on the prints over time.

### SUMMARY OF THE INVENTION

The heat-activated dry adhesive mounting paper of the present invention avoids such undesirable side effects of known adhesive mounting papers and tissues.

The present invention provides an apparatus for mounting to an art sheet such as a photograph or Giclee print, or to a mounting substrate such as a rigid mounting substrate. In one embodiment, the apparatus comprises a paper sheet comprised of cotton fibers and having a discontinuous adhesive coating on at least one side thereof, wherein the discontinuous adhesive coating comprises a thermoplastic resin.

In another embodiment, the invention further provides an adhesive mounting tissue paper sheet that includes a heat-activated resin coating applied to both sides of a paper sheet. The coated paper sheet exhibits outstanding short-term and long-term chemical stability, compatibility with complex coatings on modem art such as Giclee prints, and is suitable for mounting sheet art such as fine art prints to suitable mounting substrates such as rigid mounting substrates. The adhesive mounting tissue paper sheet can be used in combination with known art mounting substrates and virtually all fine art prints with virtually no negative short-term or long-term effects on the art sheet and/or associated mounting substrates, mats, glass, and other mounting and framing materials.

The invention further provides a multi-layer art mounting package that is suitable for lamination to provide a substantially air free adhesive bond between the art sheet, adhesive mounting paper, and the substrate. The mounting package includes a base substrate, a heat-activated adhesive mounting sheet applied over the base substrate, and an art item to be mounted applied over the adhesive sheet to form a multiple-layer mounting package. The adhesive mounting paper comprises a sheet that includes a discontinuous coating applied to both sides of the paper sheet. The coating includes a pattern of raised adhesive portions divided by substantially uncoated portions. The assembled mounting package is then laminated under heat and pressure from a press. As the mounting package is heated and compressed, trapped air escapes through the valleys formed in the discontinuous adhesive layer of the adhesive sheet. The applied heat and pressure then compress and melt the adhesive coatings into continuous flat, smooth, and substantially bubble free layers, thereby producing a smooth laminated mounted art product.

The invention further provides methods of manufacturing a heat-activated adhesive mounting sheet. The method includes the steps of: providing an uncoated paper sheet, the sheet comprising cotton fibers; applying a thermoplastic resin to at least one side of the uncoated paper sheet to form a discontinuous adhesive coating having raised coated portions divided by substantially uncoated portions; and allowing the coating to cool to form a heat-activated adhesive coated mounting paper suitable for mounting of an art sheet to a mounting substrate for display and preservation of an art sheet.

The invention further provides methods of mounting an art sheet to a rigid substrate. In a preferred embodiment, the method includes the steps of providing an art sheet to be mounted; providing a coated adhesive mounting paper, the paper including a discontinuous adhesive coating of a thermoplastic resin applied to both sides of a paper substrate; providing a rigid substrate; placing the art sheet in contact with a first side of the coated tissue mounting paper; placing the rigid substrate in contact with the opposite exposed side of the coated tissue mounting paper to form a sandwich; and exposing the resulting sandwich to heat and mechanical pressure for a time sufficient to melt the adhesive coating of the coated tissue mounting paper, thereby forming a laminated mounted product.

Advantages of the present invention include excellent chemical stability of the adhesive mounting sheet, particularly where the sheet comprises a cotton rag paper. For purposes of this application, “100% cotton” means that substantially all of the fibers of the paper are entirely made of cotton. 100% cotton rag papers are chemically and physically stable over time, and are therefore particularly suitable for use in art preservation and display applications.

Another advantage of the present invention is that it provides a non-reactive adhesive system that has excellent color stability and will not cause Giclee prints to yellow.

Another advantage of the present invention is that it is virtually universal in its available application to known rigid substrates and sheet materials, particularly fine art sheet materials.

Another advantage of the present invention is that the mounting sheet adhesive provides excellent hot tack for reliable and reproducible mounting results, while being non-tacky at ambient conditions, such as during shipping, storage, and assembly of art items and mounting substrates, and at temperatures commonly encountered with such activities.

Another advantage of the present invention is that it facilitates discontinuous coating method that makes a rough uniform raised pattern in the adhesive coating, whereby air between the layers of the multi-layer mounting package is easily pushed out during laminating.

Another advantage of the discontinuous coating method is that it provides a very porous adhesive mounting paper that further permits air and moisture to escape through the paper fibers during the mounting process. This allows otherwise trapped air to escape through the paper and associated mounting materials, rather than simply from the uncompressed edges of the sandwiched mounting materials.

Yet another advantage is that the adhesive may be provided as a solid hot melt with no solvents, and therefore no solvent odor or associated solvent-based health risks are posed.

Yet another advantage of the present invention is that it provides for excellent aging, with very little change in color, chemical composition, and tensile strength over an expected period of over 20 years when used in a mounting application.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a top perspective view of the adhesive mounting paper present invention in a first embodiment.

FIG. 2 is a side perspective view of the adhesive mounting paper of FIG. 1

FIG. 3 is a side perspective view of an assembled mounting package utilizing a two-sided embodiment of the adhesive mounting paper of the present invention.

FIG. 4 is a top perspective view of the adhesive mounting paper present invention in a second embodiment.

### DETAILED DESCRIPTION OF THE INVENTION

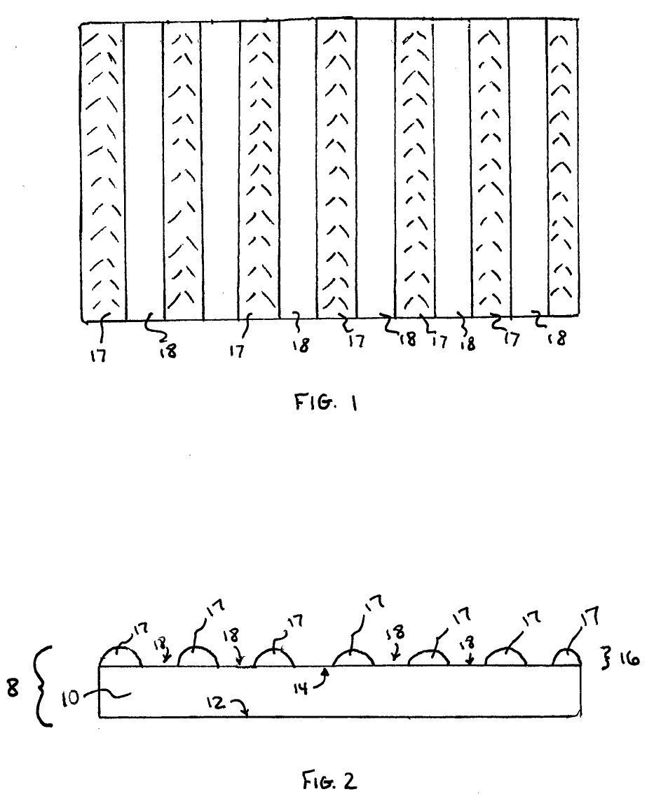

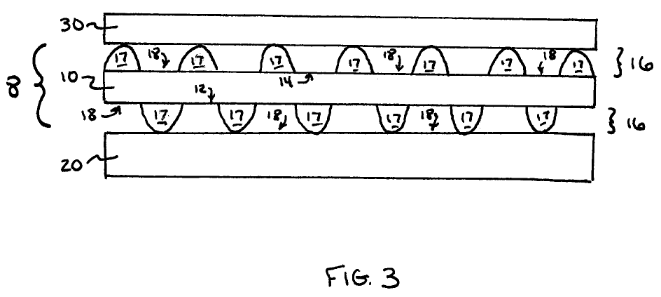

As shown in FIGS. 1-2, the apparatus of the invention is a paper sheet 10 having a discontinuously applied adhesive coating 16 applied to at least one side 12, 14 thereof to form a coated adhesive mounting sheet 8. For purposes of this application, “discontinuous” means that the coating is applied to the surface of the paper sheet so as to yield portions or areas on the papersurface having raised deposits of the thermoplastic resin coating, as well as areas or portions of the paper surface having little or no thermoplastic resin deposited thereon. In contrast, “continuous” means that the entire paper surface is covered by the coating to render a substantially uniformly thick thermoplastic resin coating.

The paper sheet includes fibers that are joined together by binders and other known paper ingredients, and the paper fibers may be woven or unwoven. Preferably, the paper sheet 10 is a cotton-based paper sheet that has an uncoated basis weight of between about 13 to about 14 pounds per ream. The paper sheet 10 is preferably of the cotton rag variety, and is more preferably 100% cotton rag. The paper sheet 10 further preferably has a medium to high porosity as measured by the standard gurley test of approximately 500 seconds (+ or −100 seconds) per 100 cc. An exemplary paper sheet 10 suitable for use in the present invention is marketed by the Esleeck Paper Mill, Turners Falls, Mass. under the trademark “NAME NATURAL TRACING BOND.”

The adhesive coating 16 is comprised of thermoplastic resin, such as ethylene acrylic acid (“EAA”). A preferred adhesive coating 16 is an extrusion type resin such as that sold by Dow Chemical Corporation of Midland, Mich. sold under the trademark PRIMACOR #3330. However, other thermoplastic resins may be used either alone or together with EAA, including but not limited to ethylene methacrylic acid (“EMA”), copolymers, and combinations thereof. For example, the thermoplastic resin may be an extrusion resin comprising a ethylene-methacrylate copolymer having a methacrylic acid content of 8% by weight and an MFR of 8 g/10 minutes, such as that marketed as Newcrel 0908C by Mitsui Dupont Polychemical Co.

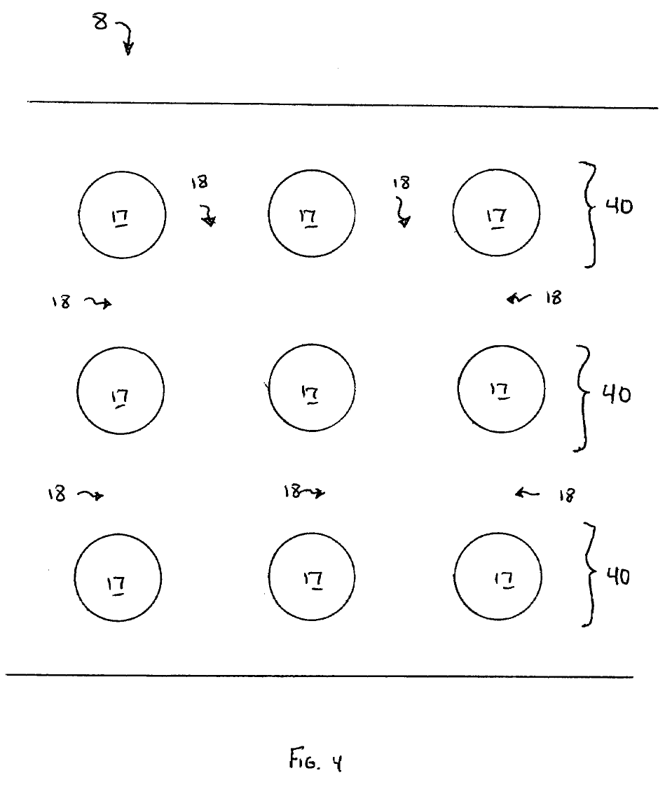

The adhesive coating 16 is applied in a discontinuous manner to yield discrete areas of adhesive coating 16 on the surface of the paper, the adhesive areas divided by substantially uncoated areas 18. The coating 16 is preferably applied using rotogravure hot cylinder coating methods. In one example, the coating 16 comprising EAA resin was applied to both sides 12, 14 of an uncoated web of a 100% cotton fiber sheet 10 using a 55-line quad rotogravure hot cylinder. In this embodiment, the coating 16 was applied by making two passes on the coating line, one pass per side 12, 14 to produce a double-sided adhesive coated paper, as shown in FIG. 3. Following coating, the coated paper web is cooled, preferably by passing over an in-line chill roll. Following cooling and setting of the resin coating, the coated paper web can be wound into a master roll, and/or can be cut, sheeted, and packaged for sale to consumers. For example, the finished adhesive mounting sheet 8 has about 26 lbs. of coating of thermoplastic resin total per ream, equating to about 13 lbs. per side based on a 3000 sq. foot ream.

The coated paper sheet 8 of the present invention includes a discontinuous coating pattern that includes raised portions 17 are formed by the adhesive coating 16 and the substantially uncoated areas 18 interposed between the raised portions 17 of the coated areas. For example, the pattern of the adhesive coating 16 may be symmetric or asymmetric. By way of further example, the surface area covered by the raised portions 17 of the adhesive coating is roughly equal to the surface area of the substantially uncoated areas 18, so that upon lamination the adhesive forms a substantially uniform coating 16 between the paper sheet 10 and the art item 30, or between the sheet 10 and the substrate 20. After lamination, the substantially uniform coating 16 is substantially free of bubbles and other forms of trapped air.

As shown in the example of FIG. 3, the discontinuous pattern permits air to escape from between the layers 8, 20, 30 of a multi-layer art mounting package during laminating. In one embodiment, the mounting package includes a base substrate 20, an adhesive sheet 8 applied over the base substrate, and an art item 30 to be mounted applied over the adhesive sheet 8 to form a multiple layer mounting package. The adhesive sheet 8 comprises a discontinuous coating 16 on at least one side 12, 14, and preferably on both sides 12, 14. The coating 16 forms raised coated portions 17 divided by substantially uncoated areas 18 to form air escape valleys. The assembled mounting package is then laminated under heat and pressure, such as in a mechanical press, vacuum press, or vacuum chamber. As the mounting package is compressed, trapped air escapes through the valleys formed in the discontinuous adhesive layer of the adhesive sheet 8. The applied heat and pressure then compress and melt the discontinuous adhesive coating 16 into a substantially continuous flat smooth layer that is substantially free of trapped air, thereby producing a smooth laminated product.

In another example shown in FIG. 4, the discontinuous adhesive coating 16 is provided as a pattern of multiple distinct cells 40, each cell comprising a raised adhesive portion 17 entirely surrounded by substantially uncoated areas 18. In the illustrated example, the coating 16 is comprised of a series of symmetric cells 40, each cell 40 having a hemispherical raised adhesive portion 17 surrounded by substantially uncoated areas 18. For example, where the geometric configuration of the cells 40 includes a raised portion 17 as a hemisphere, the width of each discontinuous substantially uncoated portion 18 may be substantially uniform. Preferably, the distance between each raised portion 17 is greater than a diameter of each hemispherical portion 17. The inventor has found that embodiments consistent with FIG. 4 can be made on a 100% cotton paper sheet 10 using a rotogravure cylinder having an etched surface cell pattern of approximately 55 lines per inch, with other process parameters as previously described herein.

In one method of using a double-sided embodiment of the adhesive mounting paper 8 of the invention, a heated piece of mounting equipment, such as a mechanical or vacuum press, is heated to a temperature sufficient to melt a thermoplastic adhesive coating 16 of a provided adhesive mounting sheet 8. A sheet art item 30, such as a photograph or art print, is provided. The art item 30 is placed in contact with a first side 14 of the previously described discontinuous adhesive mounting sheet 8. A substrate 20 is provided, and is placed in contact with the opposite exposed side 12 of the mounting sheet 8. The resulting sandwich (comprised of the art sheet 30, mounting sheet 8, and rigid substrate 20) is placed in a heated press, and is exposed to heat and mechanical pressure for a time sufficient to melt the adhesive coating 16 of the mounting sheet 8. The melted adhesive coating 16 adheres to the art sheet 30 and substrate 20, as well as to the paper sheet 10, thereby forming a multiple-layered laminated art product.

Next, the laminated mounted art product is removed from the press and allowed to cool, whereupon the adhesive coating 16 sets to form a permanent bond, retaining its desirable flexibility and adhesive properties simply upon cooling back to ambient temperature. Notably, the adhesive 16 coating, being a thermoplastic resin, does not require any additional time to set, and does not undergo any chemical curing or cross-linking after setting, thus permitting a long-lasting, chemically and mechanically stable mounting with virtually no degradation over time.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for mounting a sheet art item to a substrate, the apparatus comprising a paper sheet comprising cotton fibers, the paper sheet further comprising a first discontinuous adhesive coating on a first side thereof, the first discontinuous adhesive coating comprising a thermoplastic resin.

2. The apparatus of claim 1, wherein the paper sheet comprises substantially 100% cotton fibers.

3. The apparatus of claim 1, wherein the thermoplastic resin is comprised of at least one of ethylene acrylic acid, ethylene methacrylic acid, methacrylate copolymers, or combinations thereof.

4. The apparatus of claim 1, wherein the first discontinuous adhesive coating is configured to remove air from between the first side of the paper sheet and the sheet art item during lamination of the paper sheet and art item.

5. The apparatus of claim 4, wherein the sheet surface area covered by the raised portions of the first discontinuous adhesive coating is approximately equal to the sheet surface area covered by the substantially uncoated portions of the first discontinuous coating.

6. The apparatus of claim 1, wherein the raised portions of the first discontinuous coating comprise cells that are entirely surrounded by substantially uncoated portions.

7. The apparatus of claim 1, further comprising a second side opposite the first side, the second side comprising a second discontinuous adhesive coating comprising a thermoplastic resin.

8. The apparatus of claim 7, wherein the paper sheet comprises substantially 100% cotton fibers.

9. The apparatus of claim 7, wherein the thermoplastic resin of the second discontinuous coating is comprised of at least one of ethylene acrylic acid, ethylene methacrylic acid, methacrylate copolymers, or combinations thereof.

10. The apparatus of claim 8, wherein the second discontinuous coating comprises raised portions separated by substantially uncoated portions.

11. The apparatus of claim 8, wherein the sheet surface area covered by the raised portions of the second discontinuous coating is approximately equal to the sheet surface area covered by the substantially uncoated portions of the second discontinuous coating.

12. The apparatus of claim 8, wherein the raised portions of the second discontinuous coating comprise cells that are entirely surrounded by substantially uncoated portions.

13. A multiple layer art product suitable for lamination, the art product comprising:
a mounting substrate,
an adhesive mounting sheet applied over the mounting substrate, the adhesive mounting sheet comprising a paper sheet comprised of cotton fibers, the adhesive mounting sheet having a first side having a first discontinuous adhesive coating thereon, the first discontinuous adhesive coating comprising a thermoplastic resin, and a second side opposite the first side, the second side having a second discontinuous adhesive coating thereon, the second discontinuous adhesive coating comprising a thermoplastic resin;
a sheet art item being disposed in contact with the first discontinuous adhesive coating; and
the mounting substrate being disposed in contact with the second discontinuous adhesive coating;
wherein the first coating and the second coating are configured to remove air from between the mounting sheet, art item, and mounting substrate upon exposure to heat and mechanical pressure for a time sufficient to melt the first adhesive coating and the second adhesive coating.

14. The art product of claim 11, wherein the sheet art item is a Giclee print, and wherein the paper sheet comprises substantially 100% cotton fibers.

15. The art product of claim 11, wherein the thermoplastic resin is comprised of at least one of ethylene acrylic acid, ethylene methacrylic acid, methacrylate copolymers, or combinations thereof.

16. A method of producing an adhesive mounting paper, the method comprising the steps of:
providing an uncoated paper sheet, the sheet comprising cotton fibers;
applying a thermoplastic resin to at least one side of the uncoated paper sheet to form a discontinuous adhesive coating comprising raised coated portions divided by substantially uncoated portions; and
allowing the coating to cool to form a heat-activated adhesive coated mounting paper suitable for mounting of an art sheet to a mounting substrate for display and preservation of an art sheet.

17. The method of claim 16, wherein the paper sheet comprises substantially 100% cotton fibers.

18. The method of claim 16, wherein the thermoplastic resin is comprised of at least one of ethylene acrylic acid, ethylene methacrylic acid, orand combinations thereof.

19. The method of claim 16, wherein the surface area of the sheet having raised portions of the discontinuous coating is approximately equal to the surface area of the sheet having substantially uncoated portions.

20. The method of claim 13, wherein the step of applying a discontinuous adhesive coating comprises applying the thermoplastic resin by rotogravure methods.
